(19) United States
(12) Patent Application Publication
(10) Pub. No.: US 2022/0012830 A1
(43) Pub. Date: Jan. 13, 2022

(54) METHOD AND SYSTEM FOR AUTOMATIC ANALYSIS OF LEGAL DOCUMENTS USING SEQUENCE ALIGNEMNT

(71) Applicant: MounTavor, Inc., Palo Alto, CA (US)

(72) Inventors: Uri ZERNIK, Palo Alto, CA (US); Adam Sanford ZERNIK, Palo Alto, CA (US); Asaf SHAI, Givat Ada (IL)

(73) Assignee: MounTavor, Inc., Palo Alto, CA (US)

(21) Appl. No.: 17/372,646

(22) Filed: Jul. 12, 2021

Related U.S. Application Data
(60) Provisional application No. 63/050,443, filed on Jul. 10, 2020.

(51) Int. Cl. G06Q 50/18; G06F 40/45; G06F 40/129

(52) U.S. Cl. CPC G06Q 50/18; G06F 40/129; G06F 40/45

(57) ABSTRACT

A method and system for automatically analyzing legal documents are provided herein. The method may include the following steps: receiving a labelled legal document and at least one unlabeled legal document, wherein the legal documents exhibit similarity in terms of table of content thereof, and wherein the labelled legal document is labelled with a plurality of labels each indicating a start point and an end point of predefined entities associated with the legal documents; converting the legal documents to respective sequences of characters; applying a global alignment sequencing process to the sequence of characters of the labelled legal document and the sequence of characters of the at least one unlabeled legal document, based on the labels; deriving pointers to the start points and end points of the predefined entities in the unlabeled legal document based on the global alignment sequencing process; and labeling the unlabeled legal document using the pointers.

### CROSS REFERENCE TO RELATED APPLICATIONS

This Application claims the benefit of U.S. Provisional Patent Application No. 63/050,443, filed on Jul. 10, 2020, which is incorporated herein by reference in its entirety.

### FIELD OF THE INVENTION

The present invention relates generally to automatic document abstraction, and more particularly, to automatic document abstraction of legal documents.

### BACKGROUND OF THE INVENTION

Document abstraction is the process of mapping a document, often a legal document, into its entities, while extracting the relationship between them and assigning values thereto. In abstracting legal documents, the objective is often to determine the various legal provisions that bind the parties involved. The process of document abstraction is usually performed manually, sometimes partially aided by computers and may be carried out by people going over documents, extracting the entities (e.g. legal entities in a legal document) and assigning them with relationship and values, where applicable. The manual process may be carried out by persons manually responding to a questionnaire which typically includes hundreds of questions about the document, assisting to gather all the relevant information about the entities and the provisions.

FIG. 1A is a sample illustrating a page taken from a lease agreement 1 where the name of the tenant has been labeled (manually) by a human user, possibly over a computerized user interface in accordance with the prior art. By the end of the manual process, all entities and provisions are extracted from the document and stored on a standard format.

A full automation of the document abstraction is very challenging technologically. In theory, a large database of labelled documents could form a basis for a training database for machine learning algorithms. In practice, it is practically impossible to receive a plurality of labelled legal documents from clients because producing the manually abstraction process is costly and time consuming.

Another reason why it is virtually impossible to create a database of labeled documents is the high level of variance in wording and style of documents of the same type (e.g., lease agreements). For the sake of example, in a case of a lease agreements, every law firm has their own wording for provisions that are essentially the same. Additionally, the entire structure of a legal document may vary from one law firm to another.

Therefore, it would be impractical and as a matter of fact technically impossible to train a machine learning model with a sufficient dataset of legal documents (of the same kind) so as to effectively apply machine learning to the document abstraction domain.

### SUMMARY OF THE INVENTION

In order to overcome the drawbacks of the prior art, the inventors of the present invention suggest applying a two-stage computerized to the document abstraction process as follows.

In a first stage, using a zero-knowledge approach, a single mostly-manually labeled document may be used to generate a label transfer function that can point on any document that is similar to the manually labeled document, where is the relative location of each and every labeled entity or provision that have been used in the labeled document.

The generation of the label transfer function can be very useful on its own in applying it to many unlabeled documents that are similar to the labeled document.

In a second stage, the label transfer function can be applied to a plurality of unlabeled documents (all similar to the aforementioned labeled document) thereby creating a database of labeled documents. That database can be suitable to train a machine learning model so that further abstraction of documents can be achieved benefiting from machine learning techniques that was previously unavailable in document abstraction.

According to some embodiments of the present invention, the inventors propose herein to use zero knowledge learning in a first stage and then use the knowledgebase that has been generated using zero knowledge, for machine learning. Zero knowledge is a type of machine learning where the training is not based on numerous samples but rather, a very small number of samples, sometimes even a single sample, based on which, the learning is performed. Zero knowledge learning is feasible in special cases where some assumptions on a sample versus the data can be made.

The inventors further suggest herein, in some embodiments of the present invention, to imitate sequence alignment used in bioinformatics and apply them on documents to detect template similarities. Sequence alignment is a way of arranging data sequences (e.g. character sequences) to identify regions of similarity that may be a consequence of functional, structural, or evolutionary relationships between the sequences. Originally, used in bioinformatics, aligned sequences of nucleotide or amino acid residues are typically represented as rows within a matrix. Gaps are inserted between the residues so that identical or similar characters are aligned in successive columns. Sequence alignments are also used for non-biological sequences, such as calculating the distance cost between strings in a natural language or in financial data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a snapshot illustrating a document possibly a lease agreement that is being labeled by a human user, possibly over a computerized user interface according to the prior art;

FIG. 1B is a block diagram illustrating non-limiting exemplary architecture of a system implementing preprocessing of the legal documents by semi-automatically labeling them in accordance with some embodiments of the present invention;

FIG. 2 is a diagram illustrating non-limiting exemplary legal document exhibiting labels applied using a semi-automatic labeling system in accordance with some embodiments of the present invention;

FIG. 3 is a diagram illustrating non-limiting exemplary data structure configured for holding pointers to entities in a manually labeled legal document in accordance with some embodiments of the present invention;

FIG. 4 is a block diagram illustrating non-limiting exemplary architecture of module for assessing similarity level between two legal documents in accordance with some embodiments of the present invention;

FIG. 5A is a block diagram illustrating non-limiting exemplary architecture of a system implementing automatic labeling of a legal document similar to previously labeled legal document in accordance with some embodiments of the present invention;

FIG. 5B is a block diagram illustrating non-limiting exemplary architecture of a system implementing the generation of a plurality of labeled documents and extracting features from them, in order to train a model in accordance with some embodiments of the present invention;

FIG. 6A is a diagram illustrating non-limiting exemplary of global alignment used in bioinformatics in accordance with the prior art;

FIG. 6B is a diagram illustrating non-limiting exemplary of modified global alignment used in legal documents in accordance with some embodiments of the present invention;

FIG. 6C is a diagram illustrating another non-limiting exemplary of modified global alignment used in legal documents in accordance with some embodiments of the present invention;

FIG. 7 is a block diagram illustrating non-limiting exemplary architecture of a labelling transfer module in accordance with some embodiments of the present invention;

FIG. 8 is a diagram illustrating non-limiting exemplary data structure configured for holding pointers to entities of an automatically labelled legal document in accordance with some embodiments of the present invention;

FIG. 9 is a diagram illustrating non-limiting exemplary legal document exhibiting labels applied using the automatic labeling computerized system in accordance with some embodiments of the present invention; and

FIG. 10 is snapshot of an output of a system in accordance with some embodiments of the present invention; and

FIG. 11 is block diagram illustrating non-limiting exemplary architecture of a computerized device implementing the system in accordance with some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Prior to the detailed description of the invention being set forth, it may be helpful to provide definitions of certain terms that will be used hereinafter.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

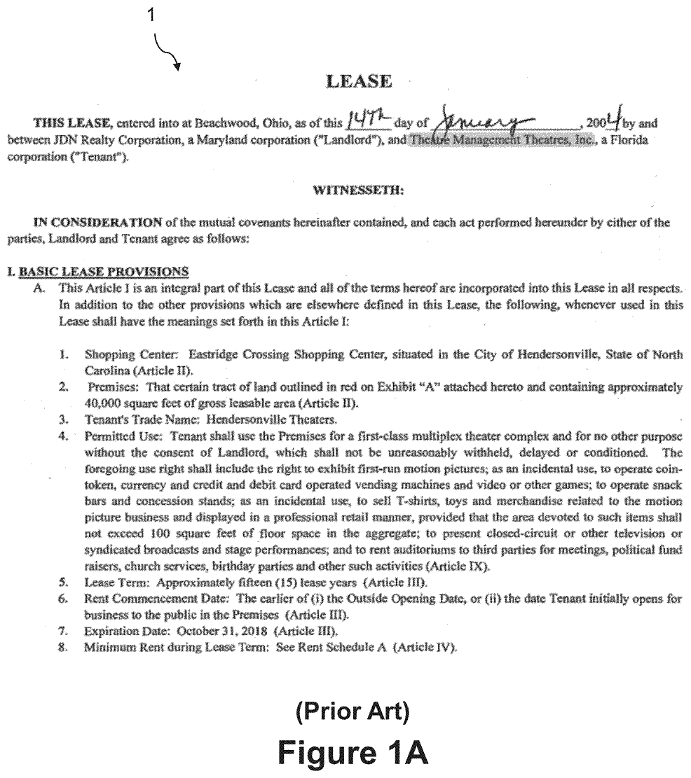

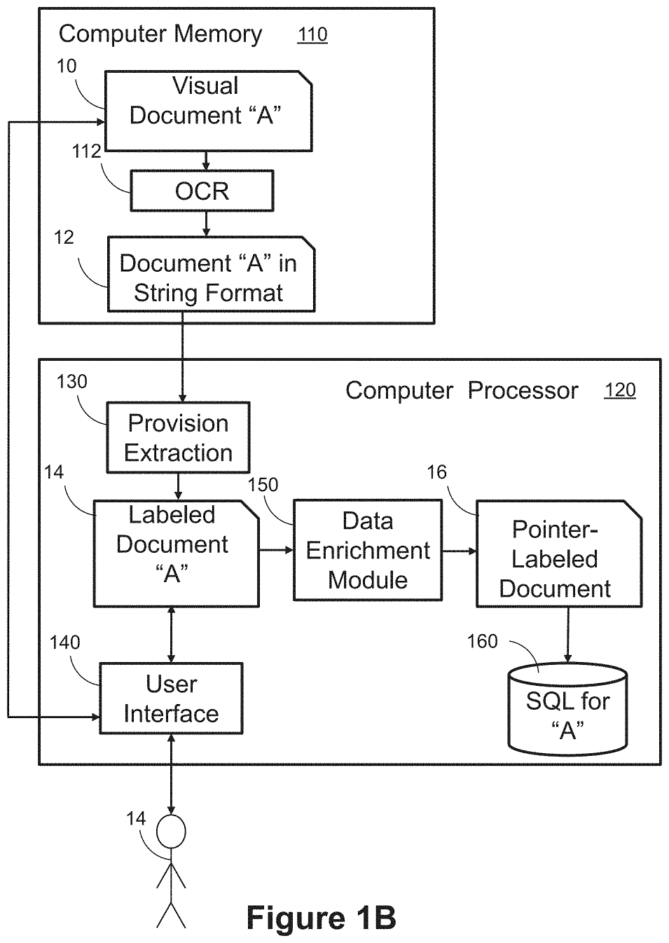

FIG. 1B is a block diagram illustrating non-limiting exemplary architecture of a system implementing a preprocessing of the legal documents by semi-automatically labeling them in accordance with some embodiments of the present invention. System 100 is a computerized platform possibly implemented as a software running on a cloud that enables one or more human users, for example human user 14 to semi automatically label a document as explained in detail hereinafter. A computer memory 110 may be configured to store a visual document “A” 10 being a document in a digitized format such as PDF format. A text conversion module such as Optical Characters Recognition (OCR) 112 may be configured to convert visual document “A” 10 into a sequence or a string of characters 12.

System 100 may further include a computer processor 120 on which a provision extraction module 130 may run, together with user interface 140. Using user interface 140, human user 14 may view visual document “A” 10 and use provision extraction module 130, to extract a plurality of entities associated with document “A”. In a case that document “A” is a legal document, the entities may be parties and their details as well as various provisions and conditions that constitute the legal transaction or contract and the like. User interface 14 may further allow human user 14 to label any or all or the extracted entities on visual document “A”, to yield a labeled document “A” that may be in a form of a sequence of characters with labels indicating where the various entities are located.

Using a data enrichment module 150 that runs on computer processor 120, a pointer-labeled document 16 is generated, being a document associated with pointers to the start points and end points of the characters that constitute any or all of the extracted entities. An SQL for “A” 160 may be configured to hold all of the pointers to the extracted entities that have been generated. The output of system 100 is a well labeled document, represented by an SQL in a manner that is sufficient to assist in an automatic labeling of any other document that exhibit a level of similarity to visual document “A” 10.

In accordance some embodiments of the present invention, the aforementioned process may be carried out once for every type of legal document, yielding an SQL or similar data structure that labels the document for future use as explained below.

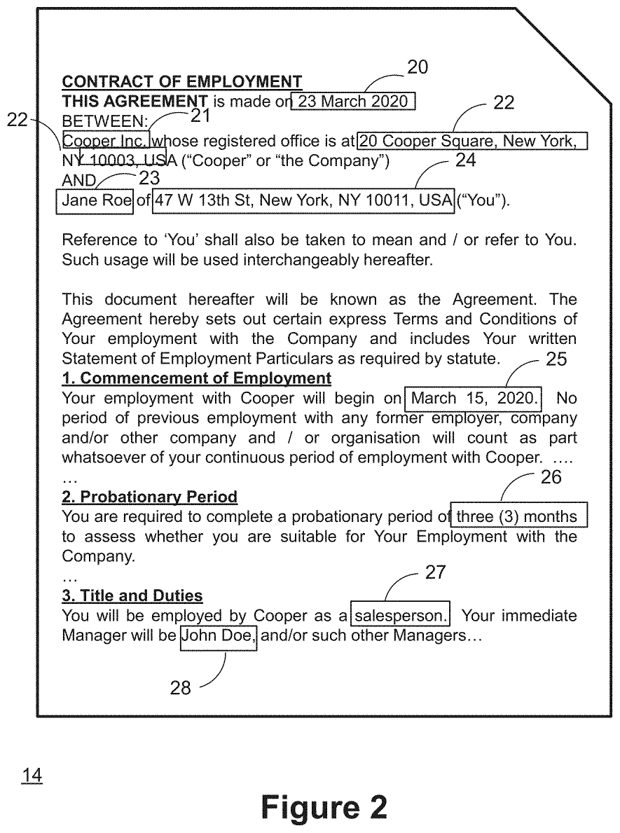

FIG. 2 is a diagram illustrating non-limiting exemplary legal document exhibiting labels applied using a semi-automatic labeling system in accordance with some embodiments of the present invention. By way of a non-limiting example, document 14 may be a labeled employment agreement exhibiting a plurality of labels associated with various entities such as: date 20, employer's name 21, employer's address 22, employee's name 23, employee's address 24, start date 25, probation period 26, position 27, and name of direct manager 28.

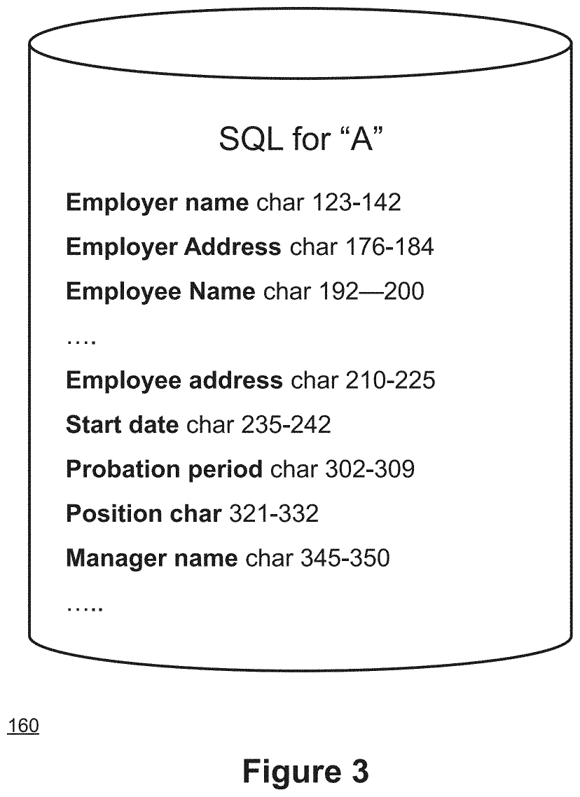

FIG. 3 is a diagram illustrating non-limiting exemplary data structure configured for holding pointers to entities in a manually labeled legal document in accordance with some embodiments of the present invention. In a non-limiting example, a SQL can hold the ranges of characters in the sequence of characters that is associated with document “A”. Thus, for example, the employer's name can be found between characters 123 and 142 of the sequence of characters. This format is suitable for using when a new unlabeled document needs to be automatically labeled as shall be explained hereinafter.

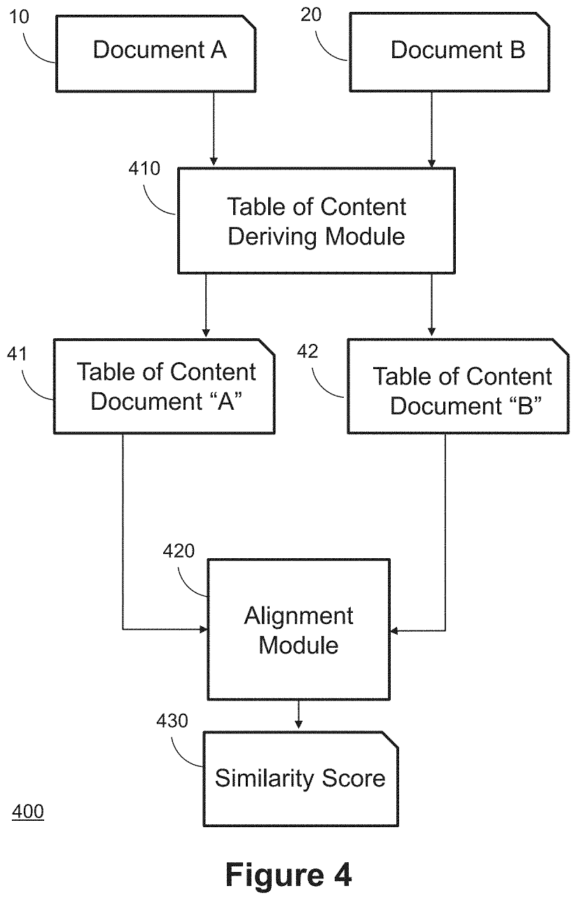

FIG. 4 is a block diagram illustrating non-limiting exemplary architecture of module for assessing similarity level between two legal documents in accordance with some embodiments of the present invention. Assessing the similarity of two documents is key for enabling a quick transfer of the labeling from one labeled document to other unlabeled documents as shall be explained below.

In order for some embodiments of the present invention to properly operate, it may be required for any unlabeled document to be similar to the labeled document. Similarity between the labeled and the unlabeled documents may take the form of Table-of-Content (ToC) similarity. Since every document (and specifically legal documents) may have a ToC based on sections, sub sections, provisions and the like, it have been suggested to determine whether two documents are similar for the purposes of the embodiments of the present invention, by comparing their ToCs.

Module 400 may be used in order to determine the level of similarity between two documents. A ToC deriving module 410, possibly running on a computer processor (not shown) may receive as an input, document “A” 10 and document “B” 20 and derive as outputs, Table of Content for document A 41 and Table of Content for document B 42. These two respective tables of content are fed into an alignment module 420 that may apply global alignment process, to yield a similarity score indicative of the similarity score 430 between the documents. It can be set so that only for a level of similarity, above a predefined score, an automatic labeling of a document may be feasible in accordance with embodiments of the present invention.

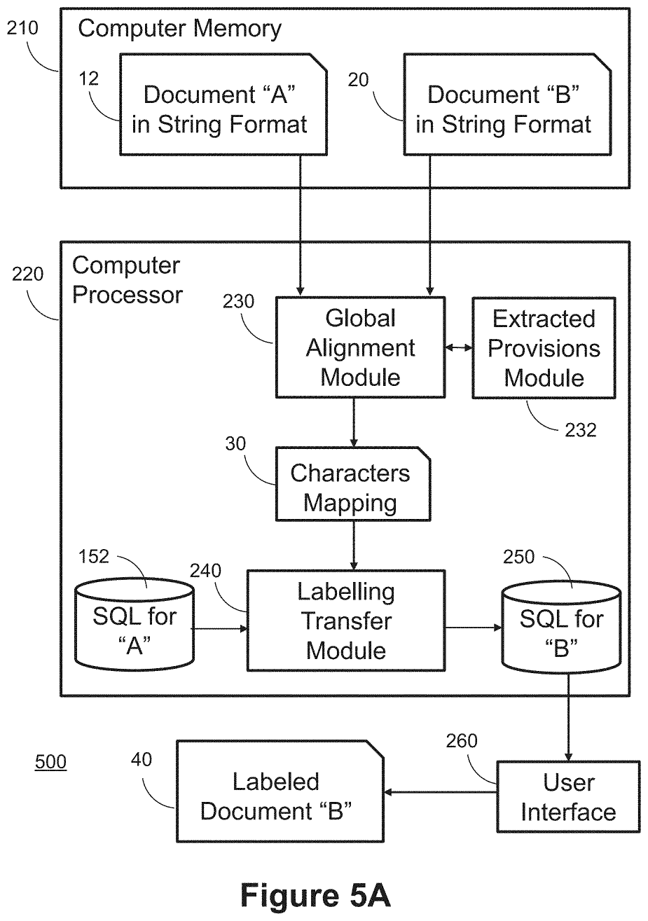

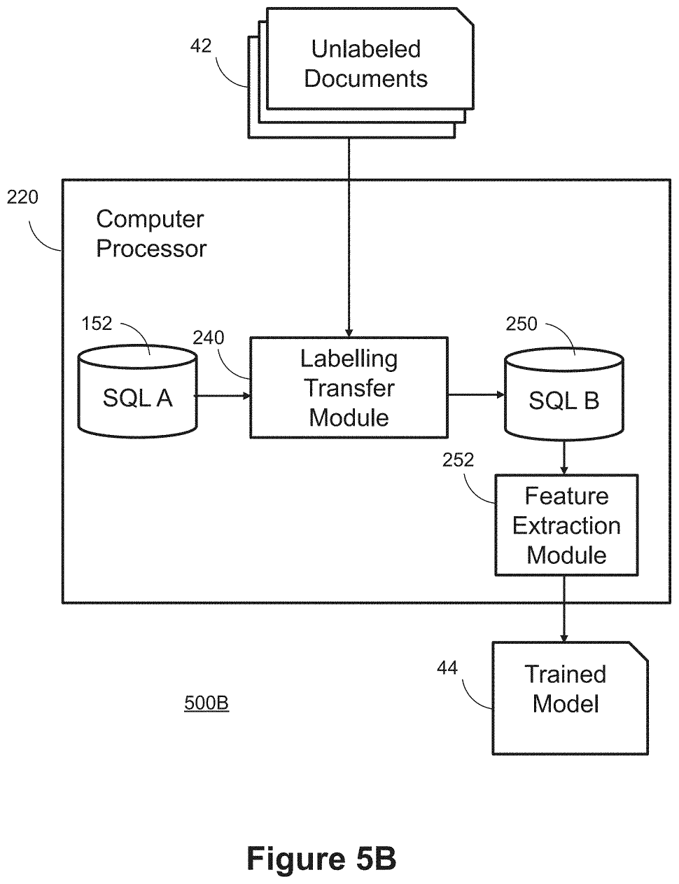

FIG. 5A is a block diagram illustrating non-limiting exemplary architecture of a system implementing automatic labeling of a legal document similar to previously labeled legal document in accordance with some embodiments of the present invention. A system 500 for automatically analyzing legal documents may include a computer memory 210 that receives a labelled legal document “A” 12 and at least one unlabeled legal document “B” 20 wherein the legal documents exhibit similarity in terms of table of content thereof, and wherein the labelled legal document is labelled with a plurality of labels each indicating a start point and an end point of predefined entities associated with said legal documents.

According to some embodiments of the present invention, only documents exhibiting a sufficient similarity score (e.g., calculated as explained above) may be used effectively. There is a trade-off between the similarity score of two documents and the accuracy of the transfer of labeling as explained below.

According to some embodiments of the present invention, labelled legal document “A” 12 and at least one unlabeled legal document “B” 20 may be stored in string format (e.g., a sequence of characters) after applying a text conversion module (not shown here) to respective visual documents “A” and “B” so as to convert the legal documents to respective sequences of characters.

System 500 may further include a global alignment module 230 running on computer processor 220 which applies a global alignment sequencing process to the sequence of characters of the labelled legal document and the sequence of characters of the at least one unlabeled legal document, based on said labels, to yield character mapping 30 indicating where entities extracted start and end relatively between the two documents.

The characters mapping is fed into a labelling transfer module 240 running on computer processor 220. Labelling transfer module 240 receives as an input, form an SQL for document “A”. all pointers to the start and end characters of the extracted entities. It then transforms, based on characters mapping 30, the respective pointer to the respective entities on document “B” so as to generate an SQL for document “B” 250 holding all the start and end characters of the entities in document “B” in pointers format.

System 500 may further include a user interface 260 or an automatic labeling module that enables to visually mark on a visual document “B” all the labels that are associate with the extracted entities, thereby generating labeled document “B” 40 using the pointers on SQL for document “B” 250.

According to some embodiments of the present invention, the labeled document has been labeled semi-automatically using a user interface enabling provision extraction and indicating start and end points of the extracted entities.

According to some embodiments of the present invention, the similarity is determined by applying global alignment process to character sequences of table of contents of the a labelled legal document and at least one unlabeled legal document.

According to some embodiments of the present invention, the similarity is given in a form of a score and is used in order to determine applicability of the method to a specific unlabeled legal document.

According to some embodiments of the present invention, the labels of the labeled documents are provided as pointers pointing to the start and end characters of the predefined entities.

According to some embodiments of the present invention, the labeling the unlabeled legal document using the pointers is carried out by applying a transfer function created by comparing between the pointers of the labeled legal document and the pointers of the unlabeled legal document.

According to some embodiments of the present invention, whenever global alignment module 230 detects a local misalignment of the predefined entities, the system may use a dictionary possibly in a form of extracted entities module 232 of the predefined entities to improve the alignment between the predefined entities in the legal documents, by recognizing the content of the word and applying a correction of the alignment if needed.

FIG. 5B is a block diagram illustrating non-limiting exemplary architecture of a system 500B implementing the automatic generation of a plurality of labeled documents from a plurality of unlabeled documents 42 by applying the labelling transfer module 240 to them thereby extracting features via feature extraction module 252 that are being used thereafter to train a trained model 44 suitable for applying machine learning techniques on document abstraction in accordance with some embodiments of the present invention.

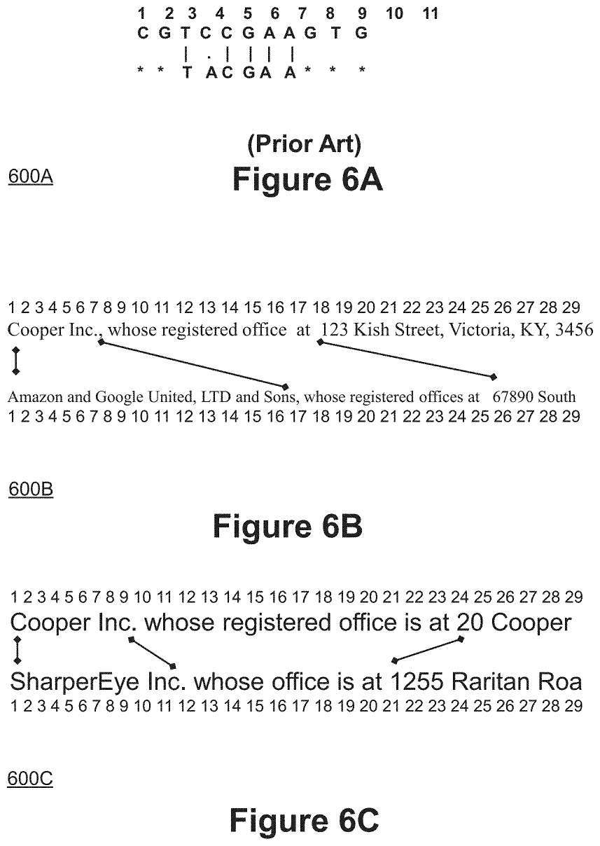

FIG. 6A is a diagram illustrating non-limiting exemplary of global alignment used in bioinformatics in accordance with the prior art. Global sequence alignment is achieved by comparing the characters in each sequence by various algorithms known in the art such as the Needleman-Wunsch algorithm. The alignment in bioinformatics is used to derive identical sequence of interest and where the non-aligned part of the sequence in not of interest.

FIG. 6B is a diagram illustrating non-limiting exemplary of modified global alignment used in legal documents in accordance with some embodiments of the present invention. In the modified global alignment, similar algorithms used in bioinformatics are used but this time the data or characters of interest starts when the aligned sequence ends and ends where the aligned sequence resumes. This is illustrate in alignment 600B showing the sequence for a legal contract where character 1 is the start point for the name of employer for both sequences and it ends on character 9 for the first sequence and character 12 for the second sequence. Similarly, the address of the employer for the first sequence starts on character 24 and on character 26 for the second sequence. The global alignment detects the sequence “whose registered office is at” and disregards it so as to trace where the entities of inters are located.

FIG. 6C is a diagram illustrating another non-limiting exemplary of modified global alignment used in legal documents in accordance with some embodiments of the present invention. The only difference from the previous example is that the sequence of so called similar content are not identical and whereas in the first sequence the text reads “whose registered office is at”, the text in the second sequence reads: “whose office is at”. Since these parts are misaligned, there is a risk the entities of interest are shifted. In accordance with some embodiments of the present invention and as explained above, a use of a dictionary applied in case of misalignment may improve the alignment and get it rectified.

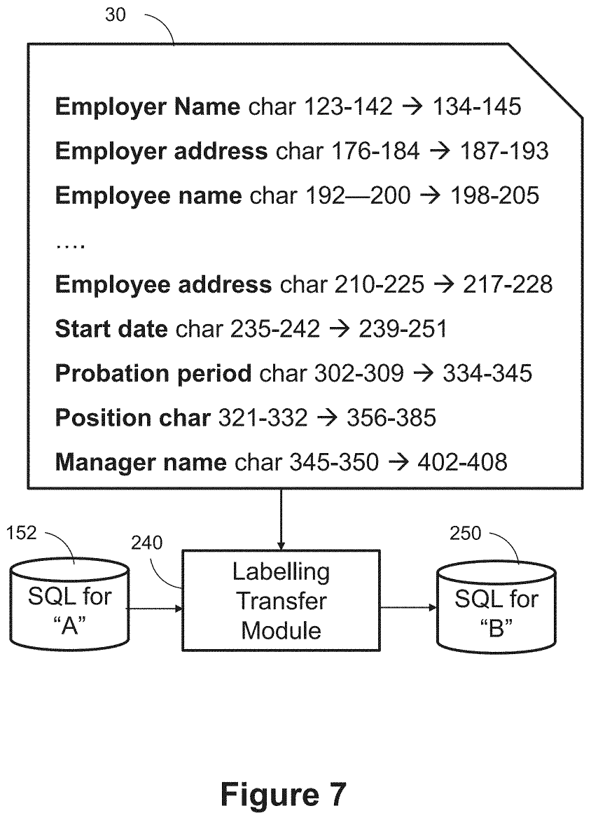

FIG. 7 is a block diagram illustrating non-limiting exemplary architecture of a labelling transfer module in accordance with some embodiments of the present invention. Characters mapping 30 mentioned above is fed into labeling transfer module 240 which in turn received SQL 152 for document “A” and build up SQL 250 for document “B”. Characters mapping 30 may show for each of the extracted entities the mapping of the character ranges in labeled document “A” and the range of respective entities in document “B”. as derived from the global alignment.

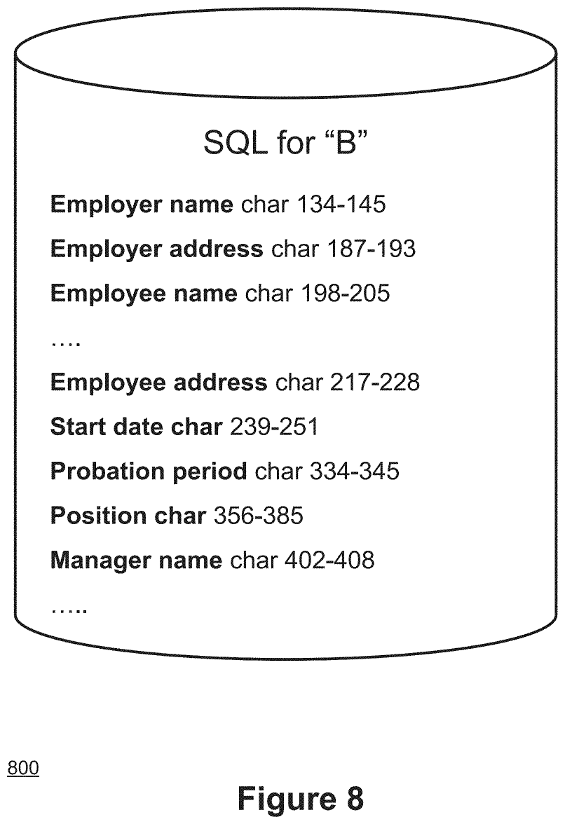

FIG. 8 is a diagram illustrating non-limiting exemplary data structure configured for holding pointers to entities of an automatically labelled legal document in accordance with some embodiments of the present invention. SQL 800 illustrates the pointers to the characters where entities of interest are located.

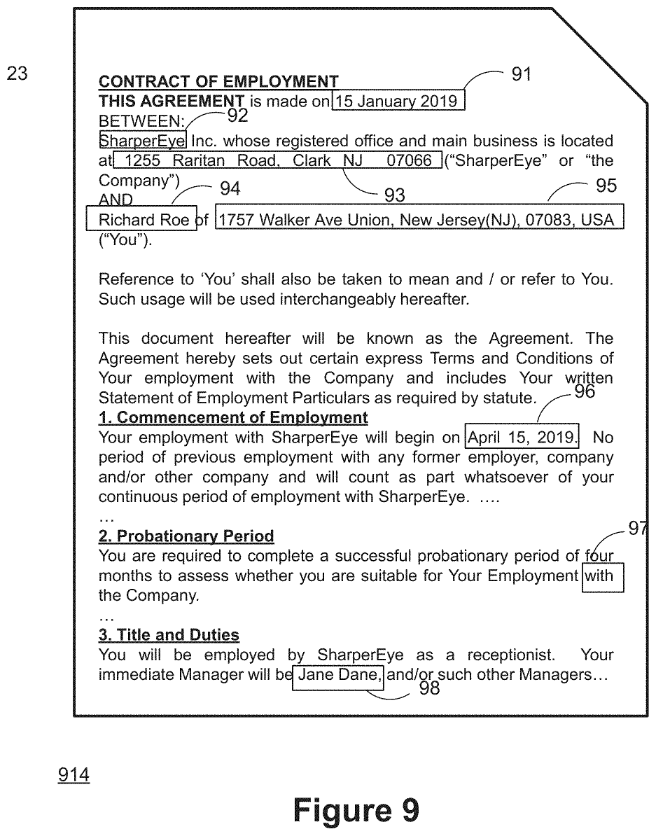

FIG. 9 is a diagram illustrating non-limiting exemplary legal document exhibiting labels applied using the automatic labeling computerized system in accordance with some embodiments of the present invention. The visual representation may be optional and an additional feature on top of the generation of the SQL for document “B”. Such a visual representation assists human users in locating upon document “B” all labels of respective entities of interest, as derived from document “A”.

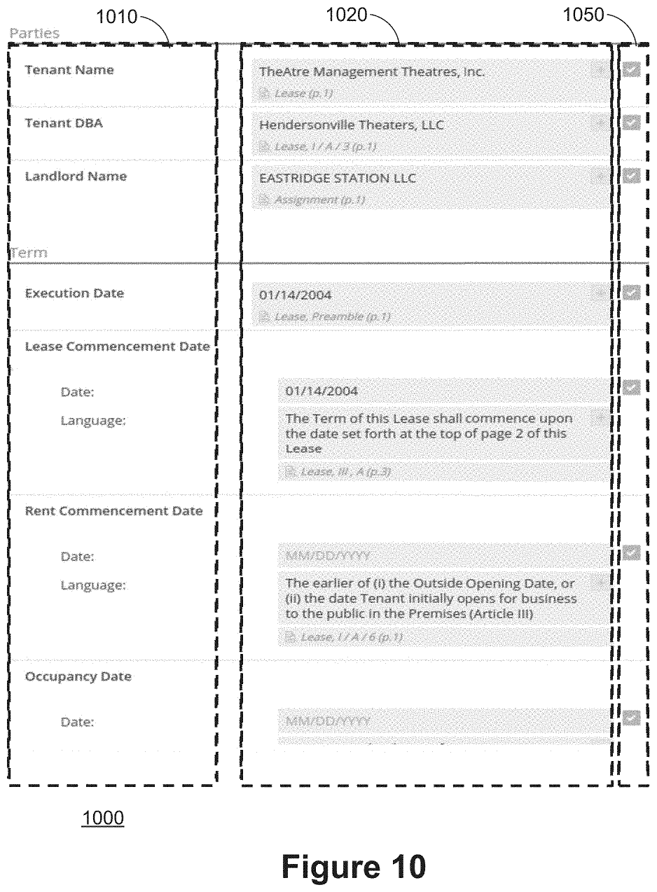

FIG. 10 is snapshot 1000 of a computer programs illustrating of an output of a system in accordance with some embodiments of the present invention. A table is indicating the various fields 1010 (e.g., entities and provisions) of interest as provided by a client and the values 1020 automatically detected by the system in accordance with embodiments of the present invention as explained above. Lastly, a column of ticked and unticked boxes 1030 serve as quality assurance possibly by a human user who audits the values and confirms it accuracy.

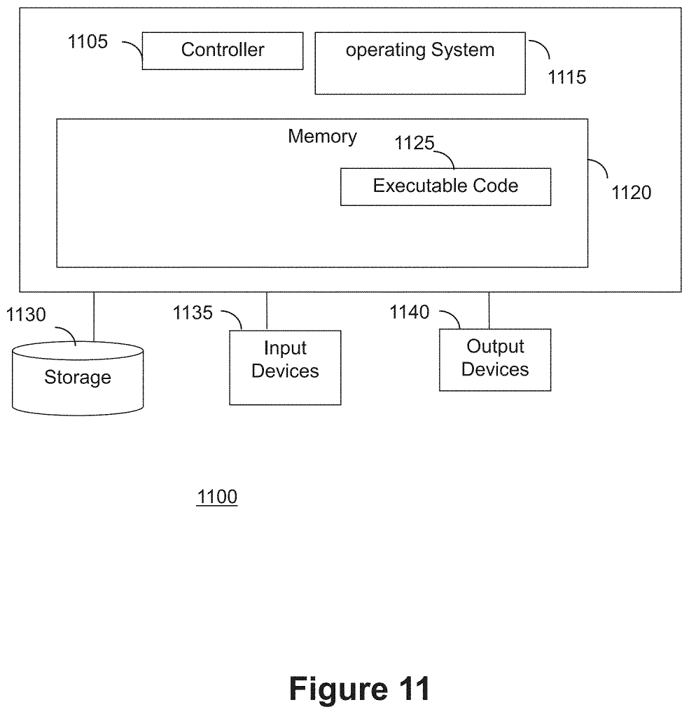

FIG. 11 is block diagram illustrating non-limiting exemplary architecture of a computerized device implementing the system in accordance with some embodiments of the present invention. In accordance with some embodiments of the present invention, the aforementioned system for automatic labeling of legal documents may be presented as a Computing device 1100 which can be used with embodiments of the invention. Computing device 1100 can include a controller or processor 1105 that can be or include, for example, one or more central processing unit processor(s) (CPU), one or more Graphics Processing Unit(s) (GPU or GPGPU), a chip or any suitable computing or computational device, an operating system 1115, a memory 1120, a storage 1130, input devices 1135 and output devices 1140.

Operating system 1015 can be or can include any code segment designed and/or configured to perform tasks involving coordination, scheduling, arbitration, supervising, controlling or otherwise managing operation of computing device 1100, for example, scheduling execution of programs. Memory 1120 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 1020 can be or can include a plurality of, possibly different memory units. Memory 1020 can store for example, instructions to carry out a method (e.g., code 1125), and/or data such as user responses, interruptions, etc.

Executable code 1125 can be any executable code, e.g., an application, a program, a process, task or script. Executable code 1125 can be executed by controller 1105 possibly under control of operating system 1115. For example, executable code 1125 can when executed cause masking of personally identifiable information (PII), according to embodiments of the invention. In some embodiments, more than one computing device 1100 or components of device 1100 can be used for multiple functions described herein. For the various modules and functions described herein, one or more computing devices 1100 or components of computing device 1100 can be used. Devices that include components similar or different to those included in computing device 1100 can be used and can be connected to a network and used as a system. One or more processor(s) 1105 can be configured to carry out embodiments of the invention by for example executing software or code. Storage 1130 can be or can include, for example, a hard disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 1130 and can be loaded from storage 1130 into a memory 1120 where it can be processed by controller 1105.

Input devices 1135 can be or can include for example a mouse, a keyboard, a touch screen or pad or any suitable input device. It will be recognized that any suitable number of input devices can be operatively connected to computing device 1100 as shown by block 1135. Output devices 1140 can include one or more displays, speakers and/or any other suitable output devices. It will be recognized that any suitable number of output devices can be operatively connected to computing device 1100 as shown by block 1140. Any applicable input/output (I/O) devices can be connected to computing device 1100, for example, a wired or wireless network interface card (NIC), a modem, printer or facsimile machine, a universal serial bus (USB) device or external hard drive can be included in input devices 1135 and/or output devices 1040.

Embodiments of the invention can include one or more article(s) (e.g., memory 1120 or storage 1130) such as a computer or processor non-transitory readable medium, or a computer or processor non-transitory storage medium, such as for example a memory, a disk drive, or a USB flash memory, encoding, including, or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing”, “computing”, “calculating”, “determining”, “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random-access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above-described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random-access memory (RAM) module, a read only memory (ROM) module, a computer hard drive, a memory card (e.g., universal serial bus (USB) flash drive, a secure digital (SD) flash card), and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above-described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above-described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A method of automatically analyzing legal documents, the method comprising:
receiving a labelled legal document and at least one unlabeled legal document, wherein the legal documents exhibit similarity in terms of table of content thereof, and wherein the labelled legal document is labelled with a plurality of labels each indicating a start point and an end point of predefined entities associated with said legal documents;
converting the legal documents to respective sequences of characters;
applying a global alignment sequencing process to said sequence of characters of the labelled legal document and the sequence of characters of the at least one unlabeled legal document, based on said labels;
deriving pointers to said start points and end points of the predefined entities in the unlabeled legal document based on said global alignment sequencing process; and
labeling the unlabeled legal document using said pointers,
wherein said converting, said applying, said deriving, and said labeling are carried out using a computer processor.

2. The method according to claim 1, wherein the labeled document has been labeled semi-automatically using a user interface enabling provision extraction and indicating start and end points of the extracted entities.

3. The method according to claim 1, wherein the similarity is determined by applying global alignment process to character sequences of table of contents of said a labelled legal document and at least one unlabeled legal document.

4. The method according to claim 3, wherein the similarity is given in a form of a score and is used in order to determine applicability of said method to a specific unlabeled legal document.

5. The method according to claim 1, wherein the labels of the labeled documents are provided as pointers pointing to the start and end characters of the predefined entities.

6. The method according to claim 5, wherein said labeling the unlabeled legal document using said pointers is carried out by applying a transfer function created by comparing between the pointers of the labeled legal document and the pointers of the unlabeled legal document.

7. The method according to claim 1, wherein whenever said applying a global alignment sequencing process comprises local misalignment of the predefined entities, the method further comprises using a dictionary of said predefined entities to improve the alignment between the predefined entities in the legal documents.

8. A system for automatically analyzing legal documents, the system comprising:
a computer memory that receives a labelled legal document and at least one unlabeled legal document, wherein the legal documents exhibit similarity in terms of table of content thereof, and wherein the labelled legal document is labelled with a plurality of labels each indicating a start point and an end point of predefined entities associated with said legal documents;
a text conversion module that converts the legal documents to respective sequences of characters;
a global alignment module that applies a global alignment sequencing process to said sequence of characters of the labelled legal document and the sequence of characters of the at least one unlabeled legal document, based on said labels;
a labelling transfer module that derives pointers to said start points and end points of the predefined entities in the unlabeled legal document based on said global alignment sequencing process; and
a labeling module that labels the unlabeled legal document using said pointers.

9. The system according to claim 8, wherein the labeled document has been labeled semi-automatically using a user interface enabling provision extraction and indicating start and end points of the extracted entities.

10. The system according to claim 8, wherein the similarity is determined by applying global alignment process to character sequences of table of contents of said a labelled legal document and at least one unlabeled legal document.

11. The system according to claim 10, wherein the similarity is given in a form of a score and is used in order to determine applicability of said method to a specific unlabeled legal document.

12. The system according to claim 8, wherein the labels of the labeled documents are provided as pointers pointing to the start and end characters of the predefined entities.

13. The system according to claim 12, wherein said labeling the unlabeled legal document using said pointers is carried out by applying a transfer function created by comparing between the pointers of the labeled legal document and the pointers of the unlabeled legal document.

14. The system according to claim 8, wherein whenever said global alignment module detects a local misalignment of the predefined entities, a dictionary of said predefined entities is used to improve the alignment between the predefined entities in the legal documents.

15. A non-transitory computer readable storage medium for automatically analyzing legal documents, the computer readable storage medium comprising a set of instructions that when executed cause at least one computer processor to:
receive a labelled legal document and at least one unlabeled legal document, wherein the legal documents exhibit similarity in terms of table of content thereof, and wherein the labelled legal document is labelled with a plurality of labels each indicating a start point and an end point of predefined entities associated with said legal documents;
convert the legal documents to respective sequences of characters;
apply a global alignment sequencing process to said sequence of characters of the labelled legal document and the sequence of characters of the at least one unlabeled legal document, based on said labels;
derive pointers to said start points and end points of the predefined entities in the unlabeled legal document based on said global alignment sequencing process; and
label the unlabeled legal document using said pointers.

16. The non-transitory computer readable storage medium according to claim 15, wherein the labeled document has been labeled semi-automatically using a user interface enabling provision extraction and indicating start and end points of the extracted entities.

17. The non-transitory computer readable storage medium according to claim 15, wherein the similarity is determined by applying global alignment process to character sequences of table of contents of said a labelled legal document and at least one unlabeled legal document.

18. The non-transitory computer readable storage medium according to claim 17, wherein the similarity is given in a form of a score and is used in order to determine applicability of said method to a specific unlabeled legal document.

19. The non-transitory computer readable storage medium according to claim 15, wherein the labels of the labeled documents are provided as pointers pointing to the start and end characters of the predefined entities.

20. The non-transitory computer readable storage medium according to claim 19, wherein said labeling the unlabeled legal document using said pointers is carried out by applying a transfer function created by comparing between the pointers of the labeled legal document and the pointers of the unlabeled legal document.
